(19) United States
(12) Patent Application Publication
(10) Pub. No.: US 2025/0261047 A1
(43) Pub. Date: Aug. 14, 2025

(54) USER EQUIPMENT AND METHOD OF RESOURCE ALLOCATION AND CHANNEL ACCESS IN SIDELINK COMMUNICATION

(71) Applicant: GUANGDONG OPPO MOBILE TELECOMMUNICATIONS CORP., LTD., Dongguan (CN)

(72) Inventor: Huei-Ming LIN, Taipei (TW)

(21) Appl. No.: 19/097,231

(22) Filed: Apr. 1, 2025

Related U.S. Application Data
(63) Continuation of application No. PCT/CN2022/138766, filed on Dec. 13, 2022.

(51) Int. Cl. H04W 28/26; H04W 92/18

(52) U.S. Cl. CPC H04W 28/26; H04W 92/18

(57) ABSTRACT

A method of resource allocation and channel access in sidelink communication by a user equipment (UE) includes identifying, by the UE, one or more candidate reserved resources, wherein the UE is configured to share its channel occupancy time (COT) with the one or more candidate reserved resources, or the UE is configured to utilize a shared COT from the one or more candidate reserved resources.

### CROSS-REFERENCE TO RELATED APPLICATION

This application is a Continuation Application of PCT/CN2022/138766 filed Dec. 13, 2022, which is incorporated herein by reference in its entirety.

### TECHNICAL FIELD

The present disclosure relates to the field of communication systems, and more particularly, to a user equipment (UE) and a method of resource allocation and channel access in sidelink communication, which can provide a good communication performance and/or provide high reliability.

### BACKGROUND

In the advancement of radio wireless transmission and reception directly between two devices, which is often known as device-to-device (D2D) communication, it was first developed by 3rd generation partnership project (3GPP) and introduced in Release 12 (officially specified as sidelink communication) and improved in Release 13 for public safety emergency usage such as mission critical communication to support mainly low data rate and voice type of connection. In 3GPP Release 14, 15, and 16, the sidelink technology was advanced to additionally support vehicle-to-everything (V2X) communication as part of global development of intelligent transportation system (ITS) to boost road safety and advanced/autonomous driving use cases. To further expand the support of sidelink technology to wider applications and devices with limited power supply/battery, the technology was further enhanced in Release 17 in the area of power saving and transceiver link reliability. For Release 18, 3GPP is currently looking to evolve the wireless technology and expand its operation into unlicensed frequency spectrum for larger available bandwidth, faster data transfer rate, and easier market adoption of D2D communication using sidelink without requiring any mobile cellular operator's involvement to allocate and configure a part of their expansive precious radio spectrum for data services that do not go throughput their mobile networks.

Therefore, there is a need for a user equipment (UE) and a method of resource allocation and channel access in sidelink communication.

### SUMMARY

In a first aspect of the present disclosure, a user equipment (UE) includes an identifier configured to identify one or more candidate reserved resources, where the UE is configured to share its channel occupancy time (COT) with the one or more candidate reserved resources, or the UE is configured to utilize a shared COT from the one or more candidate reserved resources.

In a second aspect of the present disclosure, a method of resource allocation and channel access in sidelink communication by a user equipment (UE) includes identifying, by the UE, one or more candidate reserved resources, where the UE is configured to share its channel occupancy time (COT) with the one or more candidate reserved resources, or the UE is configured to utilize a shared COT from the one or more candidate reserved resources.

In a third aspect of the present disclosure, a user equipment (UE) includes a memory, a transceiver, and a processor coupled to the memory and the transceiver. The UE is configured to perform the above method.

In a fourth aspect of the present disclosure, a non-transitory machine-readable storage medium has stored thereon instructions that, when executed by a processor of a user equipment (UE), cause the UE to perform the above method.

In a fifth aspect of the present disclosure, a chip includes a processor, configured to call and run a computer program stored in a memory, to cause a device in which the chip is installed to execute the above method.

In a sixth aspect of the present disclosure, a non-transitory computer readable storage medium, in which a computer program is stored, causes a computer to execute the above method.

In a seventh aspect of the present disclosure, a computer program product includes a computer program, and the computer program causes a computer to execute the above method.

In an eighth aspect of the present disclosure, a computer program causes a computer to execute the above method.

### BRIEF DESCRIPTION OF DRAWINGS

In order to illustrate the embodiments of the present disclosure more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a block diagram of user equipments (UEs) of communication in a communication network system according to an embodiment of the present disclosure.

FIG. 2 is a schematic diagram illustrating a user plane protocol stack according to an embodiment of the present disclosure.

FIG. 3 is a schematic diagram illustrating a control plane protocol stack according to an embodiment of the present disclosure.

FIG. 4 is a flowchart illustrating a method of resource allocation and channel access in sidelink communication by a UE according to an embodiment of the present disclosure.

FIG. 5 is a schematic diagram illustrating an exemplary proposed sidelink (SL) resource selection for collaborative/assistive channel access just prior to an existing reserved resource according to an embodiment of the present disclosure.

FIG. 6 is a schematic diagram illustrating an exemplary proposed SL resource selection for collaborative/assistive channel access after an existing reserved resource according to an embodiment of the present disclosure.

FIG. 7 is a block diagram of a UE for wireless communication according to an embodiment of the present disclosure.

FIG. 8 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

### Shared/Unlicensed Spectrum

Traditionally, the shared (also referred as unlicensed or license-exempted) radio spectrum in 2.4 GHz, 5 GHz, and 6 GHz frequency bands are commonly used by Wi-Fi and Bluetooth wireless technologies for short range communication (from just a few meters to few tens of meters). It is often claimed that more traffic is carried over the unlicensed spectrum bands than any other radio bands, since the frequency spectrum is free/at no-cost to use by anyone as long as the communication devices are compliant to certain technical regulations set out in each region. Besides Wi-Fi and Bluetooth, other radio access technologies (RATs) such as licensed-assisted access (LAA) based on 4G-LTE and new radio unlicensed (NR-U) based on 5G-NR mobile systems from 3GPP also operate in the same unlicensed bands. In order for devices of different RATs (Wi-Fi, Bluetooth, LAA, NR-U, and possibly others) to operate simultaneously and coexistence fairly in the same geographical area without causing severe interference and interruption to each other's transmission, a clear channel access (CCA) protocol such as listen-before-talk (LBT) adopted in LAA and NR-U and carrier sense multiple access/collision avoidance (CSMA/CA) used in Wi-Fi and Bluetooth are performed before any wireless transmission is carried out to ensure that a wireless radio does not transmit while another is already transmitting on the same channel.

For the sidelink wireless technology to operate and also coexistence with existing RATs already operating in the unlicensed bands, LBT based schemes can be employed to make certain there is no on-going activity on the radio channel before attempting to access the channel for transmission. For example, when a type 1 LBT is successfully performed by a sidelink user equipment (UE), the UE has the right to access and occupy the unlicensed channel for a duration of a channel occupancy time (COT). This is called COT initiation. During an acquired COT, however, a device of another RAT could still gain access to the channel if no wireless transmission is performed by the COT initiation sidelink UE or a COT responding sidelink UE for an idle period longer than a pre-defined length (e.g., 16 μs or 25 μs). Hence, potentially losing the access to the channel until another successful LBT is performed. A potential solution to this issue of losing the access to the channel could be a back-to-back (B2B) transmission.

### B2B Transmission/Multi-Consecutive Slots Transmission (MCSt)

The main purpose of B2B transmission (which can be also referred as “burst transmission” or “multi-consecutive slot transmission”) is intended for a sidelink (SL) communicating UE to occupy an unlicensed channel continuously for a longer duration of time (i.e., more than one time slot) to mitigate the risk of losing access to the unlicensed channel to a wireless transmission (Tx) device of another radio access technology (RAT). This B2B transmission can be particular important and useful for a SL Tx-UE operating in an unlicensed radio frequency spectrum that has a large size of data transport block (TB) or medium access control (MAC) packet data unit (PDU), requires multiple retransmissions, sidelink hybrid automatic repeat request (SL-HARQ) feedback is disabled, and/or with a short latency requirement (small packet delay budget, PDB). When the unlicensed wireless channel is busy/congested (e.g., with many devices trying to access the channel simultaneously for transmission), it can be difficult and take up a long time to gain access to the channel due to the random backoff timer and priority class category in the LBT procedure. And hence, when a UE finally has a chance/opportunity to gain access to the wireless channel for a channel occupancy time (COT) length which may last for a few milliseconds (e.g., 2 ms, 4 ms, 6 ms, or 10 ms), the intention is to retain the channel access for as long as possible (e.g., all or most of the COT length) to send as much data as possible by continuously transmitting in the unlicensed channel such that wireless devices of other RATs would not have a chance to access the channel.

### Unlicensed Channel Access and Occupancy

As mentioned previously, a type 1 LBT procedure can be perform by a UE before any SL transmission to first gain an access to an unlicensed channel and to initiate a COT. Additionally, a B2B transmission could be used to avoid large transmission gaps in order to retain the COT and the access to the channel. Beside the type 1 LBT, a type 2 LBT could be also used by the UE during a COT or a shared COT as required by unlicensed spectrum regulation for gaps that are 25 μs or smaller. For example, in a type 2A LBT if an unlicensed channel is sensed to be idle for 25 μs or more, the COT initiating UE is permitted to resume its transmission, and/or a COT sharing UE is allowed to start its transmission within a COT. In a type 2B LBT, the allowed transmission gap is 16 μs and type 2C LBT (for which the UE does not need to perform channel sensing) is for gaps less than 16 μs.

In the NR-U and LAA systems, transmission gaps are unavoidable/inevitable before UE occupying the unlicensed channel due to propagation delay between gNB/gNB to the UEs in sending scheduling control information, UE switching from a receiving mode (RX) to a transmitting mode (TX), and data information encoding and modulation for an actual uplink (UL) transmission. Sometimes, these gaps could be larger than 25 μs and an extension of cyclic prefix may be first transmitted in the UL in order to avoid the unlicensed channel being taken over by other devices operating in the same spectrum band due to excessive channel idle time). The duration of the such cyclic prefix extension (CPE) transmission in the UL is determined by the base station (gNB/eNB) to avoid any access blocking/denying issue among different UEs and it is indicated to each scheduled UE, and the UE simply follows the indication and performs UL transmission accordingly.

In SL communication, especially in resource allocation (RA) mode 2, all transmission resources are to be determined and selected by the UE on its own without any base station intervention, assistance, and coordination to avoid transmission collisions. Furthermore, the SL system enables frequency domain multiplexing (FDM) of transmissions from multiple UEs in the same slot such that radio resource utilization efficiency is maximized and shortened the communication latency at the same time. But since there is no base station control and assistance to SL UEs in accessing the unlicensed channel(s), even in RA mode 1 under a gNB scheduling, the UEs may try to access the channel at different time and using different LBT channel access procedures with different channel idle period requirements. Under this type of operating scenario, it is not possible to coordinate in advanced among the UEs transmitting in the same slot to avoid access blocking/denying to the unlicensed channel.

### Inter-UE Blocking in Channel Access Procedure

As described earlier, a type 1 LBT can be first performed by a UE to gain access to the unlicensed channel before any SL signal or channel can be transmitted within an initiated COT duration. More specifically, according to the existing type 1 LBT channel access procedure used in NR-U, the time length in which the UE performs the “listening”/“sensing” on the channel depends on the access priority class of the channel/signals to be transmitted. When the access priority class is high (e.g., for urgent packets with a short latency requirement), the required time length for the LBT listening/sensing could be as short as one orthogonal frequency division multiplexing (OFDM) symbol (a SL transmit slot has 14 OFDM symbols) in a most ideal case with the lowest allowable contention window size. When the access priority class is low, the LBT listening/sensing time length could be as long as a few hundreds of OFDM symbols (which would require many SL transmit slots to complete). If the unlicensed channel is sensed to be busy during the LBT procedure, an access counter stops until the channel is idle again. This inherently has an issue of inter-UE blocking among SL transmitting UE. That is, if a UE is trying to access an unlicensed channel by performing the type 1 LBT while others are already transmitting on the channel, the UE is blocked in this case by other UEs and may experience difficulty in completing the channel access procedure and gaining an access to the channel. This phenomenon is often referred as inter-UE blocking in channel access procedure.

### Mode 2 Resource Allocation Mechanism in Sidelink

In the existing design of resource allocation mechanism for SL communication, a mode 2 resource selection method relies on the SL transmitting UE to perform autonomous selection of resources from a SL resource pool for its own transmission of data messages. In this method, the selection of transmission resources is not random but based on a sensing and reservation strategy to avoid collision with other SL transmission UEs operating in the same resource pool. In this resource selection strategy, a transmitting UE senses the channel within a sensing window (which is different from the LBT channel sensing) to detect and decode SL resource reservation information from other transmitting UEs. Based on the received resource reservation information, the UE excludes the reserved resources from selection to avoid TX collision. Likewise, the UE also sends out/broadcast its own resource reservation information in the resource pool when it transmits data and control messages, so that other UEs may avoid selecting the same or an overlap resource. In the existing resource selection and reservation signaling design, the time gap between two consecutive resources for reservation can be up to 31 slots apart. With this type of resource selection method, it is not ideal for MCSt as there is no guarantee that resources may be selected contiguously in time.

In some embodiments, for the present proposed method of resource allocation and channel access for sidelink communication in an unlicensed channel, SL radio resources are selected by a transmitting UE in a manner that assist or collaborate with another UE such that the overall burden of performing the type 1 LBT channel access procedure by both UEs and the above-mentioned inter-UE blocking issue are reduced. Other benefits from using the proposed resource selection and channel access method for SL communication in the unlicensed spectrum also include:

Less SL transmission droppings caused by inter-UE blocking means less re-selection of resources and faster/earlier delivery of data packets with reduced latency.

Less re-selection of resources means less SL transmissions without any prior resource reservation. Subsequently, a reduced likelihood of transmission collision can lead to higher reliability of the data packet delivery.

Higher chance of data packet data being delivered successfully also results in a smaller number of SL transmissions in the unlicensed channel, which means less traffic congestion and more available resources for others.

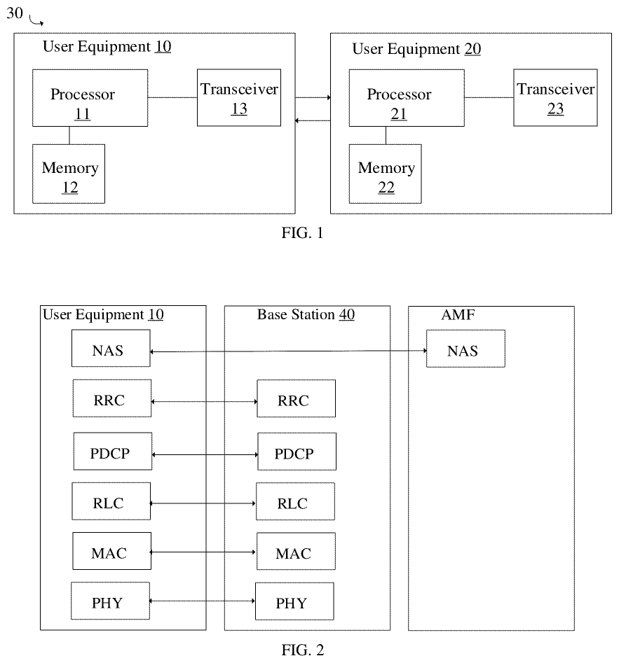

FIG. 1 illustrates that, in some embodiments, one or more user equipments (UEs) 10 (such as a first UE) and one or more user equipments (UEs) 20 (such as a second UE) of communication in a communication network system 30 according to an embodiment of the present disclosure are provided. The communication network system 30 includes one or more UEs 10 and one or more UE 20. The UE 10 may include a memory 12, a transceiver 13, and a processor 11 coupled to the memory 12 and the transceiver 13. The UE 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21 and transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

The communication between UEs relates to vehicle-to-everything (V2X) communication including vehicle-to-vehicle (V2V), vehicle-to-pedestrian (V2P), and vehicle-to-infrastructure/network (V2I/N) according to a sidelink technology developed under 3rd generation partnership project (3GPP) long term evolution (LTE) and new radio (NR) releases 17, 18 and beyond. UEs are communicated with each other directly via a sidelink interface such as a PC5 interface. Some embodiments of the present disclosure relate to sidelink communication technology in 3GPP NR release 17 and beyond, for example providing cellular-vehicle to everything (C-V2X) communication.

In some embodiments, the UE 10 may be a sidelink packet transport block (TB) transmission UE (Tx-UE). The UE 20 may be a sidelink packet TB reception UE (Rx-UE) or a peer UE. The sidelink packet TB Rx-UE can be configured to send ACK/NACK feedback to the packet TB Tx-UE. The peer UE 20 is another UE communicating with the Tx-UE 10 in a same SL unicast or groupcast session.

FIG. 2 illustrates an example user plane protocol stack according to an embodiment of the present disclosure. FIG. 2 illustrates that, in some embodiments, in the user plane protocol stack, where service data adaptation protocol (SDAP), packet data convergence protocol (PDCP), radio link control (RLC), and media access control (MAC) sublayers and physical (PHY) layer (also referred as first layer or layer 1 (L1) layer) may be terminated in a UE 10 and a base station 40 (such as gNB) on a network side. In an example, a PHY layer provides transport services to higher layers (e.g., MAC, RRC, etc.). In an example, services and functions of a MAC sublayer may comprise mapping between logical channels and transport channels, multiplexing/demultiplexing of MAC service data units (SDUs) belonging to one or different logical channels into/from transport blocks (TBs) delivered to/from the PHY layer, scheduling information reporting, error correction through hybrid automatic repeat request (HARQ) (e.g. one HARQ entity per carrier in case of carrier aggregation (CA)), priority handling between UEs by means of dynamic scheduling, priority handling between logical channels of one UE by means of logical channel prioritization, and/or padding. A MAC entity may support one or multiple numerologics and/or transmission timings. In an example, mapping restrictions in a logical channel prioritization may control which numerology and/or transmission timing a logical channel may use. In an example, an RLC sublayer may supports transparent mode (TM), unacknowledged mode (UM) and acknowledged mode (AM) transmission modes. The RLC configuration may be per logical channel with no dependency on numerologies and/or transmission time interval (TTI) durations. In an example, automatic repeat request (ARQ) may operate on any of the numerologies and/or TTI durations the logical channel is configured with. In an example, services and functions of the PDCP layer for the user plane may comprise sequence numbering, header compression, and decompression, transfer of user data, reordering and duplicate detection, PDCP PDU routing (e.g., in case of split bearers), retransmission of PDCP SDUs, ciphering, deciphering and integrity protection, PDCP SDU discard, PDCP re-establishment and data recovery for RLC AM, and/or duplication of PDCP PDUs. In an example, services and functions of SDAP may comprise mapping between a QoS flow and a data radio bearer. In an example, services and functions of SDAP may comprise mapping quality of service Indicator (QFI) in downlink (DL) and uplink (UL) packets. In an example, a protocol entity of SDAP may be configured for an individual PDU session.

FIG. 3 illustrates an example control plane protocol stack according to an embodiment of the present disclosure. FIG. 2 illustrates that, in some embodiments, in the control plane protocol stack where PDCP, RLC, and MAC sublayers and PHY layer may be terminated in a UE 10 and a base station 40 (such as gNB) on a network side and perform service and functions described above. In an example, RRC used to control a radio resource between the UE and a base station (such as a gNB). In an example, RRC may be terminated in a UE and the gNB on a network side. In an example, services and functions of RRC may comprise broadcast of system information related to AS and NAS, paging initiated by 5GC or RAN, establishment, maintenance and release of an RRC connection between the UE and RAN, security functions including key management, establishment, configuration, maintenance and release of signaling radio bearers (SRBs) and data radio bearers (DRBs), mobility functions, QoS management functions, UE measurement reporting and control of the reporting, detection of and recovery from radio link failure, and/or non-access stratum (NAS) message transfer to/from NAS from/to a UE. In an example, NAS control protocol may be terminated in the UE and AMF on a network side and may perform functions such as authentication, mobility management between a UE and an AMF for 3GPP access and non-3GPP access, and session management between a UE and a SMF for 3GPP access and non-3GPP access.

When a specific application is executed and a data communication service is required by the specific application in the UE, an application layer taking charge of executing the specific application provides the application-related information, that is, the application group/category/priority information/ID to the NAS layer. In this case, the application-related information may be pre-configured/defined in the UE. (Alternatively, the application-related information is received from the network to be provided from the AS (RRC) layer to the application layer, and when the application layer starts the data communication service, the application layer requests the information provision to the AS (RRC) layer to receive the information.)

In some embodiments, the processor 11 is configured to identify one or more candidate reserved resources, where the processor 11 is configured to share its channel occupancy time (COT) with the one or more candidate reserved resources, or the processor 11 is configured to utilize a shared COT from the one or more candidate reserved resources. This can solve issues in the prior art, reduce an overall burden of performing a type 1 listen-before-talk (LBT) channel access procedure by one or more UEs, reduce an inter-UE blocking issue, provide less re-selection of resources, provide faster/earlier delivery of data packets with reduced latency, provide a reduced likelihood of transmission collision, provide a higher reliability of the data packet delivery, provide less traffic congestion and more available resources for others, provide a good communication performance, and/or provide high reliability.

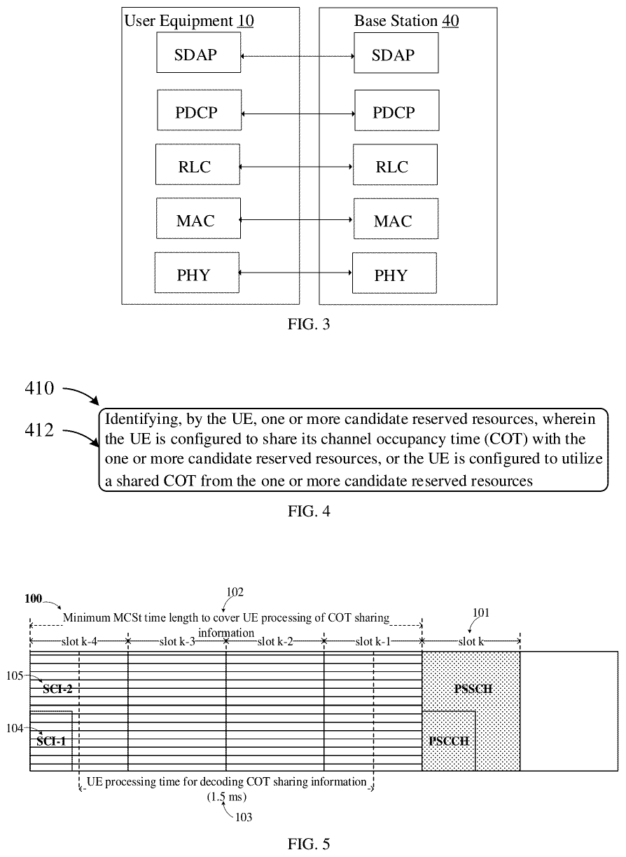

FIG. 4 illustrates a method 410 of resource allocation and channel access in sidelink communication by a UE according to an embodiment of the present disclosure. In some embodiments, the method 410 includes: a block 412, identifying, by the UE, one or more candidate reserved resources, where the UE is configured to share its channel occupancy time (COT) with the one or more candidate reserved resources, or the UE is configured to utilize a shared COT from the one or more candidate reserved resources. This can solve issues in the prior art, reduce an overall burden of performing a type 1 listen-before-talk (LBT) channel access procedure by one or more UEs, reduce an inter-UE blocking issue, provide less re-selection of resources, provide faster/earlier delivery of data packets with reduced latency, provide a reduced likelihood of transmission collision, provide a higher reliability of the data packet delivery, provide less traffic congestion and more available resources for others, provide a good communication performance, and/or provide high reliability.

In some embodiments, identifying, by the UE, the one or more candidate reserved resources is based on at least one of following criteria: an availability of candidate resources in consecutive slots for multi-consecutive slots transmission (MCSt) with a number of slots covering a UE processing time to decode a COT sharing information; a resource reserved for a unicast, groupcast, or broadcast transmission with a source/destination identifier (ID) that the UE belongs to; a channel access priority class (CAPC) level of a transmission of the UE being equal to or less than a CAPC level of the one or more candidate reserved resources; or a maximum/remaining COT sharing duration covering the UE processing time to decode the COT sharing information and a length of the one or more candidate reserved resources.

In some embodiments, the method further includes performing, by the UE, a resource selection prior to the one or more candidate reserved resources, where the UE shares its COT with another UE for the one or more candidate reserved resources. In some embodiments, based on source/destination IDs in a sidelink control information (SCI), the UE is configured to determine the one or more candidate reserved resources belonging to a same unicast, groupcast and/or broadcast sidelink communication as the UE. In some embodiments, the method further includes selecting, by the UE, a set of candidate resources for MCSt, where the set of candidate resources span across at least a same number of slots as a UE processing time of a COT sharing information. In some embodiments, the set of candidate resources are prior to the one or more candidate reserved resources belonging to a same unicast, groupcast, or broadcast sidelink communication as the UE.

In some embodiments, identifying, by the UE, the one or more candidate reserved resources is based on at least one of following criteria: an availability of at least one candidate resource that is at least a time length away from a first slot of the one or more candidate reserved resources, where the time length covers a UE processing time for decoding a COT sharing information from the one or more candidate reserved resources; a source/destination ID of an intended transmission from the UE being same as an indicated ID of the one or more candidate reserved resources; a CAPC level of a transmission of the UE being equal to or greater than a CAPC level of the one or more candidate reserved resources; or a maximum/remaining COT sharing duration from the one or more candidate reserved resources covering the UE processing time to decode the COT sharing information and a length of the intended transmission from the UE.

In some embodiments, the method further includes selecting, by the UE, the at least one candidate resource after an identified candidate reserved resource, where the UE is configured to utilize the shared COT from the identified candidate reserved resource. In some embodiments, based on source/destination IDs in an SCI, the UE is configured to determine the one or more candidate reserved resources belonging to a same unicast, groupcast and/or broadcast sidelink communication as the UE. In some embodiments, the at least one candidate resource after a first slot of one or more identified candidate reserved resources belong to the same unicast, groupcast, or broadcast sidelink communication as the UE. In some embodiments, a source/destination ID of a sidelink transmission from the UE matches to a same ID from the one or more identified candidate reserved resources or as a part of additional IDs in the COT sharing information from the UE of the one or more candidate reserved resources. In some embodiments, the method further includes performing, by the UE, a type 2 channel access procedure by utilizing the shared COT from the one or more candidate reserved resources. In some embodiments, when the one or more candidate reserved resources are for a sidelink unicast transmission, the source/destination ID of the intended transmission from the UE contains a source/destination ID of the one or more candidate reserved resources. In some embodiments, when the one or more candidate reserved resources are for a sidelink groupcast or broadcast transmission, the source/destination ID of the intended transmission from the UE is the same source/destination ID of the one or more candidate reserved resources.

In the above embodiments, the term “configured” can refer to “pre-configured” and “network configured”. The term “pre-defined” or “pre-defined rules” in the present disclosure may be achieved by pre-storing corresponding codes, tables, or other manners for indicating relevant information in devices (e.g., including a UE and a network device). The implementation is not limited in the present disclosure. For example, “pre-defined” may refer to those defined in a protocol. It is also to be understood that in the disclosure, “protocol” may refer to a standard protocol in the field of communication, which may include, for example, a LTE protocol, NR protocol and relevant protocol applied in the future communication system, which is not limited in the present disclosure.

### EXAMPLES

In some embodiments, for the present disclosure of a new method for a collaborative/assisted channel access into an unlicensed/shared frequency spectrum channel, radio resources are strategically selected by a sidelink (SL) transmitting user equipment (Tx-UE) based on one or more existing reservations of resources in the resource pool. Whenever appropriate, the selection of transmission resources by the SL Tx-UE can take into account of processing time required to receive and decode a channel occupancy time (COT) sharing information.

As mentioned previously, in order to gain access to an unlicensed/shared frequency channel, according to regulation on the frequency usage in certain regions of the world, a UE device is mandated to perform a listen-before-talk (LBT) channel access procedure as part of a clear channel access (CCA) protocol to ensure that the unlicensed/shared channel is not occupied by others before the UE device can begin to transmit radio signals and data on the channel. According to the regulation, it also specified that a UE device may access an unlicensed/shared channel using one of two channel access mechanisms.

Firstly, when a UE device does not have a valid channel occupancy time (COT) shared by another communication device/node (e.g., a base station node, wireless access point, UE, etc.), the UE device performs a LBT channel access procedure to sense the channel for a random duration of time within a certain range that is subject to a channel access priority class (CAPC) level of the signal/data to be transmitted. In general, when the CAPC level is high, the required LBT sensing time is shorter for a faster access. Once the UE device has successfully completed this LBT channel access procedure (i.e., channel is sensed to be idle for the random among of time within a certain rage), a COT of a certain duration is initiated by the UE device, and the UE device has a right to access and transmit on the unlicensed/shared channel within the COT. This LBT channel access procedure is known and specified as type 1 channel access procedure in 3GPP for NR-U system. As described earlier, the LBT sensing time in type 1 channel access procedure could be as short as a few OFDM symbols and as long as a few hundreds of OFDM symbols, even when the channel is not busy. Alternatively, the UE device could share the self-initiated COT with other devices, so that other devices (i.e., responding UEs) could also enjoy a fast access to the channel on a condition that the responding UEs' transmissions need to have an equal or higher CAPC level.

Secondly, when a UE device (a responding UE) has received/obtained a valid COT shared by another communication node for which the UE device can utilize it for transmitting radio signals/data on an unlicensed/shared channel, the UE device performs only a short LBT channel access procedure for a time period of 25 μs or 16 μs (which are less than one OFDM symbol length) to ensure that the channel is idle before the actual transmission. This LBT channel access procedure is known and specified as type 2 channel access procedure in 3GPP for NR-U system. Therefore, it is observed that the required LBT sensing time duration is significantly shorter for a UE device to access an unlicensed/shared channel within a shared COT compared to the case when the UE device needs to perform a full type 1 LBT channel access procedure to initiate a COT for transmission. And as described earlier, it is generally much more difficult for a UE device to gain access to a congested unlicensed/shared channel using type 1 LBT channel access procedure due to inter-UE blocking when the channel is always occupied by other UE devices' transmissions.

One possible solution to the above inter-UE blocking issue is for a UE device to avoid selecting a resource (e.g., in slot k−1) just prior to another UE's transmission (e.g., in slot k) such that the UE device's transmission may not block the another UE from performing a type 1 LBT channel access procedure (e.g. in slot k). Furthermore, according to this principle of one UE device may not transmit in a slot just prior to another UE device's transmission, a UE device may also avoid selecting a resource (e.g., in slot k+1) just right after another UE's transmission (e.g., in slot k), or otherwise, the another UE device's transmission would block the UE device from performing a type 1 LBT channel access procedure (e.g., in slot k). However, such resource selection approach for the UE device is not a good solution due to unnecessarily limiting the number of candidate resources that the UE device can select its transmission resources from. In addition, this resource selection approach may create/result in a situation where an empty slot will occur in every two SL slots due to nothing may be transmitted just before and after a slot containing a SL transmission. Moreover, as described earlier, the time required to perform a type 1 LBT channel access procedure could take much longer than one slot length. By avoiding only the slot prior and the slot after a SL transmission in the resource selection would not completely resolve the inter-UE block issue. Hence, a different solution approach is needed where the resource selection and channel access utilizing the COT sharing mechanism among SL transmissions should happen in a collaborative/assistive manner.

### Proposed Resource Selection Mechanism Based on Existing Resource Reservation

In order to collaborate and assist one another among SL transmitting UEs in accessing the unlicensed/shared channel, one may take an advantage of the COT sharing feature allowed by the regulations to reduce/minimize the burden of UE performing a type 1 LBT channel access procedure, which is prone to the inter-UE blocking issue. By sharing an initiated COT with one or more intended and eligible target receiver UEs (which can be also referred as responding UEs), according to the previously described channel access mechanism for COT sharing, the target receiver UE/responding UE of the shared COT needs to perform only a short LBT channel access procedure before its transmission. Since the short LBT sensing time can be easily accommodated by the last gap symbol of a SL slot structure, the aforementioned inter-UE blocking issue would not exist. For example, when two UEs are engaged in a SL unicast communication, it is desirable for the two UEs to share a COT for exchanging data communication, since one UE's transmission always targets and intended for the other UE.

In this kind of communication relationship, both UEs are a responding UE to one another. In a SL groupcast communication scenario, where multiple SL UEs belong to the same communication group and sharing a common group/groupcast ID, an initiated COT may be also shared by the group of UEs to facilitate the exchange of data communication to minimize the inter-UE blocking issue. The same COT sharing principle can be also apply to SL broadcast communication as well by using a common broadcast ID. It is understood that, the COT sharing is used to minimize/reduce the burden of UE performing type 1 LBT and the associated inter-UE blocking issue. Further, a target receiver UE/responding UE in a COT sharing can be determined by the unicast/groupcast/broadcast IDs.

In the existing SL mode 2 resource allocation procedure, the selection of resources is carried out in a random fashion from a set of available candidate resources. There is no specific mechanism/reason why one candidate resource may be selected over others. But before the final selection of resources for transmission, a set of candidate resources within a resource selection window needs to be first determined by the transmitting UE (Tx-UE). As described previously, SL Mode 2 resource allocation procedure is based on a sensing and reservation strategy to avoid potential collision with other SL transmission UEs, by performing a channel sensing and exclusion of resources that are already reserved by other UEs from a set of candidate resources. Then the remaining candidate resource set is reported to the UE higher layer for the final selection of resources. During the channel sensing, which is different from the LBT sensing used in type 1 and type 2 channel access procedures, UE decodes a first stage sidelink control information (SCI-1) transmitted in a physical sidelink control channel (PSCCH) from all UEs within a sensing window to identify all the reserved resources in the future. When a reserved resource fall within a resource selection window of the Tx-UE, the resource is excluded from the candidate set. Although during the mode 2 sensing procedure only the SCI-1 needs to be decoded by the Tx-UE for the resource selection purpose, the Tx-UE also needs to decode a second stage SCI (SCI-2) transmitted in a physical sidelink shared channel (PSSCH) which contains a source ID and a destination ID in order to determine whether the data content is intended for the Tx-UE.

For example, if the received destination ID in SCI-2 identifies a groupcast or unicast communication which the Tx-UE belongs to, the Tx-UE may proceed to further decode the data contents transmitted in PSSCH. From this, it is observed that SL UEs operating in the same resource pool may all need to decode at least SCI-1 and SCI-2 from all received SL transmissions to extract information on the resource reservation and the source/destination IDs. It is understood that, in mode 2 RA, although decoding only SCI-1 is needed for resource exclusion to avoid Tx collision, UEs still need to decode SCI-2 in PSSCH to determine whether the data information content is intended for the UE based on the source/destination IDs, and in SL-U, the destination ID also determines whether a shared COT can be utilized by the Tx-UE or not. Furthermore, the source/destination IDs (containing the unicast/groupcast/broadcast IDs) are also needed for the COT sharing purpose as part of channel access in order to determine whether the Tx-UE is an intended target receiver UE/responding UE and which type of channel access procedure needs to be used.

During the process of sharing a COT with other UE(s), all required information associated with a COT (e.g., target receiver UEs, remaining COT duration, frequency resources, CAPC, etc.) may be provided by the COT initiating UE and transmitted via either SCI and/or medium access control-control element (MAC CE). Some of these information such as CAPC and frequency resources may be carried in SCI-1, and others such as target receiver UEs and remaining COT duration may be carried in SCI-2 by utilizing some of the existing SCI parameter fields (e.g., source/destination IDs) to avoid duplication of information or the MAC CE. As such, the COT sharing information may be sent in both PSCCH and PSSCH, and transmitted over several OFDM symbols within a SL slot. Once these SL channels are received by the UE in an early part of a SL slot, it also takes some additional processing time for the UE to decode and extract the COT sharing information. If we assume the COT sharing information is transmitted using SCI only, this information would be transmitted in the first half of a SL slot. If we further assume it takes a SL UE 1 ms to decode PSCCH and extract the SCI, then the total UE processing time is 1.5 ms to receive and obtain the COT sharing information. In a SL communication system with 15 kHz sub-carrier spacing (SCS), this translates into 1.5 slots of UE processing time.

This means, the earliest time slot the shared COT can be utilized by the UE is from the 3rd slot, since the first two slots are used to transmit and decode the COT sharing information. In a 30 kHz SCS SL system, the earliest time slot the shared COT can be utilized by the UE is from the 4th slot. In a 60 kHz SCS SL system, the earliest time slot the shared COT can be utilized by the UE is from the 6th slot. For the case when MAC CE is also used for carrying the COT sharing information, it may take an entire SL slot to deliver the COT contents. Assuming it now takes 1.5 ms to decode the COT sharing information from both PSCCH and PSSCH, in this case the total UE processing time is 2.5 ms. In a 15 kHz SCS SL system, the earliest time slot the shared COT can be utilized by the UE is from the 4th slot, since the first three slots are used to transmit and decode the COT sharing information. In a 30 kHz SCS SL system, the earliest time slot the shared COT can be utilized by the UE is from the 5th slot. In a 60 kHz SCS SL system, the earliest time slot the shared COT can be utilized by the UE is from the 8th slot.

In some embodiments, for the inventive new method of resource selection based on an existing/current resource reservation to gain access to an unlicensed/shared channel in a collaborative/assistive manner among SL transmitting UEs operating in the same resource pool, it is proposed for a SL Tx-UE to first identify one or more candidate reserved resources (i.e., target receiver UE/responding UEs) that the SL Tx-UE is able to share its COT with or to utilized a shared COT from.

The identification of one or more candidate reserved resources that the SL Tx-UE is able to share its COT with could be based on at least one of the following criteria: 1. Availability of candidate resources in consecutive slots for MCSt with sufficient number of slots that cover a minimum/required UE processing time duration to decode a COT sharing information. 2. A resource reserved for a unicast, groupcast, or broadcast transmission with a source/destination ID that the SL TX-UE belongs to. 3. The CAPC level of the SL Tx-UE's transmission is at least equal to or less than the CAPC level of the candidate reserved resource. 4. The maximum or the remaining COT sharing duration would cover a minimum/required UE processing time duration to decode a COT sharing information and the length of the one or more candidate reserved resources.

In some embodiments, if a candidate reserved resource can be identified according to the above criteria, the SL Tx-UE may perform a resource selection just prior to the candidate reserved resource which is a target receiver UE/responding UE for sharing its COT with. It should be noted that during the SL mode 2 sensing procedure, based on the destination IDs received in the SCI, the Tx-UE would be able to determine which ones of the reserved resources belong to the same unicast, groupcast and/or broadcast SL communication that the Tx-UE is also participating/engaging in. The Tx-UE may then select a set of candidate resources for MCSt that span across at least the same number of slots as the minimum/required time length for UE processing of a COT sharing information, and the one or more candidate resources may be selected just prior to a candidate reserved resource that belongs to a same unicast, groupcast, or broadcast SL communication as the Tx-UE.

During the SL transmission (e.g., using MCSt) over the selected set of candidate resources, the COT sharing information may indicate the same ID from the candidate reserved resource (source or destination ID) as the destination ID of the SL transmission or as a part of additional IDs in the COT sharing information. So that, the UE of the candidate reserved resource is able to utilize the COT shared by the Tx-UE and perform a shorter type 2 LBT channel access procedure to avoid the inter-UE block issue and gaining a better chance of access the unlicensed/shared channel. In the case when the candidate reserved resource is for SL unicast transmission, then the COT sharing information may contain the source ID of the candidate reserved resource. In the case when the candidate reserved resource is for SL groupcast or broadcast transmission, then the COT sharing information may contain the destination ID of the candidate reserved resource, which represents the groupcast or broadcast ID that the Tx-UE belongs to.

An exemplary illustration of the proposed SL resource selection for collaborative/assistive channel access just prior to a reserved resource is illustrated in diagram 100 of FIG. 5. In diagram 100, it is assumed a candidate reserved resource 101 that meets all of the above selection criteria is identified by a SL Tx-UE during a SL mode 2 resource selection procedure. That is, there are resources available and suitable for selection by the SL Tx-UE in every one of the 4 consecutive slots 102 just prior to the candidate reserved resource that would cover the UE processing time for decoding a COT sharing information (e.g., 1.5 ms) 103, the transmission type of the candidate reserved resource 101 is unicast and the destination ID points to the SL Tx-UE, the indicated CAPC level for the candidate reserve resource is equal to or higher than the SL-Tx UE's intended transmission, and the maximum length for a COT to be initiated by the SL Tx-UE would cover both the MCSt length 102 and the candidate reserved resource 101 (i.e., at least 5 slots). Then the SL Tx-UE selects the set of available resources for MCSt 102 just prior to the candidate reserved resource 101 and performs a type 1 LBT channel access procedure to initiate a COT for MCSt 102.

During the sidelink transmission in slot k−4, the SL Tx-UE shares its COT by indicating the COT sharing information using both SCI-1 104 and SCI-2 105 in the first half of the slot k−4, and the COT sharing information would include a destination ID points to the UE of the candidate reserved resource 101 for unicast communication. For the UE that reserved the candidate reserved resource 101, it would continue to monitor/sense the unlicensed/shared channel (e.g., for resource selection and data reception purposes) and even try to perform a type 1 LBT channel access procedure for its planned transmission using the candidate reserved resource in slot k 101. During the monitoring/sensing process, the UE of the candidate reserved resource would also receive and decode the COT sharing information provided by the SL Tx-UE in SCI-1 104 and SCI-2 105 of slot k−4. Assuming the UE of the candidate reserved resource obtains the COT sharing information 1.5 ms after the reception in the middle of the slot k−1, the UE of the candidate reserved resource 101 could drop the on-going type 1 LBT channel access procedure and perform a short Type 2 LBT channel access procedure in a gap symbol at the end of slot k−1 and just before slot k to gain access to the channel. By selecting transmission resources from the SL-Tx just prior to a candidate reserved resource and sharing its COT with the UE of the candidate reserved resource, the UE of the candidate reserved resource could perform just a short type 2 LBT to gain access to the unlicensed/shared channel for its planned transmission, and thus, avoids a potential inter-UE blocking issue.

The identification of one or more candidate reserved resource(s) that the SL Tx-UE is able to utilized a shared COT from could be based on at least one of the following criteria: A. Availability of at least one candidate resource that is at least a sufficient time length away from the 1st slot of the candidate reserved resource(s). The length of the time gap may be sufficient to cover a minimum/required UE processing time for decoding a COT sharing information from the candidate reserved resource(s). B. The indicated ID of the candidate reserved resource(s) (i.e., source or destination ID) being the same as the destination ID of the intended transmission from the SL Tx-UE. Meaning the intended transmission from the SL Tx-UE is a direct response to the transmission of the candidate reserved resource(s) for sharing the COT. C. The CAPC level of the SL Tx-UE's transmission is at least equal to or higher than the CAPC level of the candidate reserved resource(s). D. The maximum or the remaining COT sharing duration from the UE of the candidate reserved resource(s) would cover a minimum/required UE processing time duration to decode a COT sharing information and a length of the intended transmission from the SL Tx-UE.

In some embodiments, if at least one candidate reserved resource can be identified according to the above criteria, the SL Tx-UE may select at least one candidate resource immediately after the identified candidate reserved resource from which the SL Tx-UE could utilize a shared COT. It should be noted that during the SL mode 2 sensing procedure, based on the destination IDs received in the SCI, the Tx-UE would be able to determine which ones of the reserved resources belong to the same unicast, groupcast, and/or broadcast SL communication that the Tx-UE is also participating/engaging in. The SL Tx-UE selection of at least one candidate resource for its own SL transmission may be after the 1st slot of the identified candidate reserved resource(s) belonging to a same unicast/groupcast/broadcast SL communication, and the slot timing for the at least one candidate resource may take into account a minimum/required time length for UE processing of a received COT sharing information.

In some embodiments, during the SL transmission from the SL Tx-UE using the selected at least one candidate resource, the destination ID of the SL transmission from the SL-Tx UE may match to the same ID from the identified candidate reserved resource(s) (source or destination ID) or as a part of additional IDs in the COT sharing information from the UE of the candidate reserved resource(s). So that, the SL Tx-UE is able to utilize the COT shared from the UE of the candidate reserved resource(s) and perform a shorter type 2 LBT channel access procedure to avoid the inter-UE blocking issue, and gaining a better chance of access the unlicensed/shared channel. In the case when the candidate reserved resource(s) is for a SL unicast transmission, then the destination ID of the intended transmission from the SL Tx-UE may contain the source ID of the candidate reserved resource(s). In the case when the candidate reserved resource(s) is for SL groupcast or broadcast transmission, then the destination ID of the intended transmission from the SL Tx-UE can be the same destination ID of the candidate reserved resource(s), which represents the groupcast or broadcast ID that the SL Tx-UE belongs to.

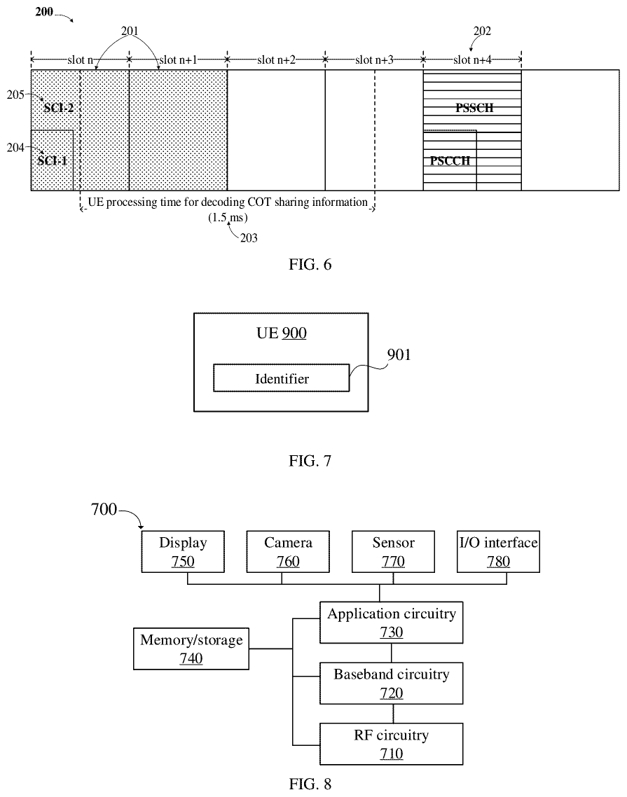

An exemplary illustration of the proposed SL resource selection for collaborative/assistive channel access after a reserved resource is shown in diagram 200 of FIG. 6. In the diagram 200, it is assumed a set of 2 candidate reserved resources 201 (in slot n and slot n+1) that meets all of the above selection criteria is identified by a SL Tx-UE during a SL mode 2 resource selection procedure. That is, there is a candidate resource available and suitable for selection by the SL Tx-UE after the set of candidate reserved resources in slot n+4 202 with a gap between the first slot of the candidate reserved resource set (slot n) and the candidate resource 202 that is sufficient to cover a minimum/required UE processing time for decoding a COT sharing information (e.g., 1.5 ms) 203, the transmission type of the candidate reserved resources 201 is groupcast and the destination ID matches to the destination ID of the intended transmission from the SL Tx-UE, the indicated CAPC level for the candidate reserve resource set 201 is equal to or less than the SL-Tx UE's intended transmission in slot n+4 202, and the maximum length for a COT initiated by UE of the candidate reserved resource set 201 would cover a minimum/required UE processing time duration to decode a COT sharing information 203 and the length of the intended transmission from the SL Tx-UE in slot n+4 202. In such case, the SL Tx-UE selects the candidate resource 202 for its own transmission after to the set of candidate reserved resources 201 in order to utilize a shared COT transmitted in SCI-1 204 and SCI-2 205 from the UE of the candidate reserved resource set 201, and performs only a type 2 LBT to gain access to the unlicensed/shared channel during a gap symbol just before the start of slot n+4 202 (i.e., at the end of slot n+3), and thus, avoids a potential inter-UE blocking issue.

For the case when no candidate reserved resource is found by the Tx-UE to share its COT with or to utilized a shared COT from, and also for the case when the Tx-UE does not attempt to find a candidate reserve resource to share its COT with or to utilized a shared COT from (i.e., a simple case of just selecting some empty resources for MCSt), the Tx-UE may still select a set of resources for MCSt that covers at least a minimum processing time length required to decode a COT sharing information such that another UE could select candidate resources immediately after the MCSt and still utilize a COT shared by the Tx-UE.

In summary, in order to improve the likelihood of gaining access into an unlicensed/shared frequency channel for SL transmitting UEs operating in the same resource pool, it is proposed for a SL transmitting UE to strategically select one or more sidelink resources with a transmission timing that is just prior to or after an existing/current reserved resource. By selecting the one or more resources just prior to an existing/current reserved resource, the intention is for the SL transmitting UE to perform a type 1 LBT to initiate a COT and share its COT for the transmission in the following reserved resource, such that the UE of the reserved resource only needs to perform a short type 2 LBT procedure and avoids a potentially long type 1 LBT channel access procedure with an uncertain outcome. As such, the inter-UE blocking effect/phenomenon that is often associated with and experienced by UE performing a type 1 LBT channel access procedure is eliminated for the reserved resource. However, the selection of resources just prior to the existing reserved resource may take into account of UE processing time to decode the COT sharing information. By selecting the one or more resources after an existing/current reserved resource, the intention is for the SL transmitting UE to take an advantage of a COT shared by the UE of the reserved resource such that the SL transmitting UE only needs to perform a short type 2 LBT procedure and avoids a potentially long type 1 LBT channel access procedure with an uncertain outcome. As such, the inter-UE blocking effect/phenomenon is eliminated for the SL transmitting UE. Similarly, the selection of resources after the existing/current reserved resource by the SL transmitting UE also needs take into account of required processing time to decode the COT sharing information from the UE of the reserved resource.

FIG. 7 illustrates a UE 900 for wireless communication according to an embodiment of the present disclosure. The UE 900 includes an identifier 901 configured to identify one or more candidate reserved resources, where the identifier 901 is configured to share its channel occupancy time (COT) with the one or more candidate reserved resources, or the identifier 901 is configured to utilize a shared COT from the one or more candidate reserved resources. The executor 901 is configured to perform the above method in the above embodiments. This can solve issues in the prior art, reduce an overall burden of performing a type 1 listen-before-talk (LBT) channel access procedure by one or more UEs, reduce an inter-UE blocking issue, provide less re-selection of resources, provide faster/earlier delivery of data packets with reduced latency, provide a reduced likelihood of transmission collision, provide a higher reliability of the data packet delivery, provide less traffic congestion and more available resources for others, provide a good communication performance, and/or provide high reliability.

In some embodiments, the identifier 901 is configured to identify the one or more candidate reserved resources based on at least one of following criteria: an availability of candidate resources in consecutive slots for multi-consecutive slots transmission (MCSt) with a number of slots covering a UE processing time to decode a COT sharing information; a resource reserved for a unicast, groupcast, or broadcast transmission with a source/destination identifier (ID) that the UE belongs to; a channel access priority class (CAPC) level of a transmission of the UE being equal to or less than a CAPC level of the one or more candidate reserved resources; or a maximum/remaining COT sharing duration covering the UE processing time to decode the COT sharing information and a length of the one or more candidate reserved resources.

In some embodiments, the identifier 901 is configured to perform a resource selection prior to the one or more candidate reserved resources, where the identifier 901 shares its COT with another UE for the one or more candidate reserved resources. In some embodiments, based on source/destination IDs in a sidelink control information (SCI), the identifier 901 is configured to determine the one or more candidate reserved resources belonging to a same unicast, groupcast and/or broadcast sidelink communication as the UE. In some embodiments, the identifier 901 is configured to select a set of candidate resources for MCSt, where the set of candidate resources span across at least a same number of slots as a UE processing time of a COT sharing information. In some embodiments, the set of candidate resources are prior to the one or more candidate reserved resources belonging to a same unicast, groupcast, or broadcast sidelink communication as the UE.

In some embodiments, the identifier 901 is configured to identify the one or more candidate reserved resources is based on at least one of following criteria: an availability of at least one candidate resource that is at least a time length away from a first slot of the one or more candidate reserved resources, where the time length covers a UE processing time for decoding a COT sharing information from the one or more candidate reserved resources; a source/destination ID of an intended transmission from the UE being same as an indicated ID of the one or more candidate reserved resources; a CAPC level of a transmission of the UE being equal to or greater than a CAPC level of the one or more candidate reserved resources; or a maximum/remaining COT sharing duration from the one or more candidate reserved resources covering the UE processing time to decode the COT sharing information and a length of the intended transmission from the UE.

In some embodiments, the identifier 901 is configured to select the at least one candidate resource after an identified candidate reserved resource, where the UE is configured to utilize the shared COT from the identified candidate reserved resource. In some embodiments, based on source/destination IDs in an SCI, the identifier 901 is configured to determine the one or more candidate reserved resources belonging to a same unicast, groupcast and/or broadcast sidelink communication as the UE. In some embodiments, the at least one candidate resource after a first slot of one or more identified candidate reserved resources belong to the same unicast, groupcast, or broadcast sidelink communication as the UE. In some embodiments, a source/destination ID of a sidelink transmission from the UE matches to a same ID from the one or more identified candidate reserved resources or as a part of additional IDs in the COT sharing information from the UE of the one or more candidate reserved resources. In some embodiments, the identifier 901 is configured to perform a type 2 channel access procedure by utilizing the shared COT from the one or more candidate reserved resources. In some embodiments, when the one or more candidate reserved resources are for a sidelink unicast transmission, the source/destination ID of the intended transmission from the UE contains a source/destination ID of the one or more candidate reserved resources. In some embodiments, when the one or more candidate reserved resources are for a sidelink groupcast or broadcast transmission, the source/destination ID of the intended transmission from the UE is the same source/destination ID of the one or more candidate reserved resources.

Commercial interests for some embodiments are as follows. 1. Solving issues in the prior art. 2. Reducing an overall burden of performing a type 1 listen-before-talk (LBT) channel access procedure by one or more UEs. 3. Reducing an inter-UE blocking issue. 4. Providing less re-selection of resources. 5. Providing faster/earlier delivery of data packets with reduced latency. 6. Providing a reduced likelihood of transmission collision. 7. Providing a higher reliability of the data packet delivery. 8. Providing less traffic congestion and more available resources for others. 9. Providing good communication performance. 10. Providing high reliability. 11. Some embodiments of the present disclosure are used by 5G-NR chipset vendors, V2X communication system development vendors, automakers including cars, trains, trucks, buses, bicycles, moto-bikes, helmets, and etc., drones (unmanned aerial vehicles), smartphone makers, smart watches, wireless earbuds, wireless headphones, communication devices, remote control vehicles, and robots for public safety use, AR/VR device maker for example gaming, conference/seminar, education purposes, smart home appliances including TV, stereo, speakers, lights, door bells, locks, cameras, conferencing headsets, and etc., smart factory and warehouse equipment including IIoT devices, robots, robotic arms, and simply just between production machines. In some embodiments, commercial interest for the disclosed application and business importance includes lowering power consumption for wireless communication means longer operating time for the device and/or better user experience and product satisfaction from longer operating time between battery charging. Some embodiments of the present disclosure are a combination of “techniques/processes” that can be adopted in 3GPP specification to create an end product. Some embodiments of the present disclosure relate to mobile cellular communication technology in 3GPP NR Releases 17, 18, and beyond for providing direct device-to-device (D2D) wireless communication services.

FIG. 8 is a block diagram of an example system 700 for wireless communication according to an embodiment of the present disclosure. Embodiments described herein may be implemented into the system using any suitably configured hardware and/or software. FIG. 8 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated.

The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

The baseband circuitry 720 may include circuitry such as, but not limited to, one or more single-core or multi-core processors. The processors may include a baseband processor. The baseband circuitry may handle various radio control functions that enables communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

The RF circuitry 710 may enable communication with wireless networks using modulated electromagnetic radiation through a non-solid medium. In various embodiments, the RF circuitry may include switches, filters, amplifiers, etc. to facilitate the communication with the wireless network.

In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the user equipment, eNB, or gNB may be embodied in whole or in part in one or more of the RF circuitry, the baseband circuitry, and/or the application circuitry. As used herein, “circuitry” may refer to, be part of, or include an application specific integrated circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules.

In some embodiments, some or all of the constituent components of the baseband circuitry, the application circuitry, and/or the memory/storage may be implemented together on a system on a chip (SOC).

The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, a AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan.

A person having ordinary skill in the art can use different ways to realize the function for each specific application while such realizations cannot go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a non-transitory readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a non-transitory storage medium, including a plurality of commands for a computational device (such as a personal computer, a server, or a network device) to run all or some of the steps disclosed by the embodiments of the present disclosure. The non-transitory storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A method of resource allocation and channel access in sidelink communication by a user equipment (UE), comprising:
identifying, by the UE, one or more candidate reserved resources, wherein the UE is configured to share its channel occupancy time (COT) with the one or more candidate reserved resources, or the UE is configured to utilize a shared COT from the one or more candidate reserved resources.

2. The method of claim 1, wherein identifying, by the UE, the one or more candidate reserved resources is based on at least one of following criteria:
an availability of candidate resources in consecutive slots for multi-consecutive slots transmission (MCSt) with a number of slots covering a UE processing time to decode a COT sharing information;
a resource reserved for a unicast, groupcast, or broadcast transmission with a source/destination identifier (ID) that the UE belongs to;
a channel access priority class (CAPC) level of a transmission of the UE being equal to or less than a CAPC level of the one or more candidate reserved resources; or
a maximum/remaining COT sharing duration covering the UE processing time to decode the COT sharing information and a length of the one or more candidate reserved resources.

3. The method of claim 1, further comprising performing, by the UE, a resource selection prior to the one or more candidate reserved resources, wherein the UE shares its COT with another UE for the one or more candidate reserved resources.

4. The method of claim 1, wherein based on source/destination IDs in a sidelink control information (SCI), the UE is configured to determine the one or more candidate reserved resources belonging to a same unicast, groupcast and/or broadcast sidelink communication as the UE.

5. The method of claim 1, further comprising selecting, by the UE, a set of candidate resources for MCSt, wherein the set of candidate resources span across at least a same number of slots as a UE processing time of a COT sharing information.

6. The method of claim 1, wherein identifying, by the UE, the one or more candidate reserved resources is based on at least one of following criteria:
an availability of at least one candidate resource that is at least a time length away from a first slot of the one or more candidate reserved resources, wherein the time length covers a UE processing time for decoding a COT sharing information from the one or more candidate reserved resources;
a source/destination ID of an intended transmission from the UE being same as an indicated ID of the one or more candidate reserved resources;
a CAPC level of a transmission of the UE being equal to or greater than a CAPC level of the one or more candidate reserved resources; or
a maximum/remaining COT sharing duration from the one or more candidate reserved resources covering the UE processing time to decode the COT sharing information and a length of the intended transmission from the UE.

7. The method of claim 6, wherein based on source/destination IDs in an SCI, the UE is configured to determine the one or more candidate reserved resources belonging to a same unicast, groupcast and/or broadcast sidelink communication as the UE.

8. The method of claim 7, wherein the at least one candidate resource after a first slot of one or more identified candidate reserved resources belong to the same unicast, groupcast, or broadcast sidelink communication as the UE.

9. A user equipment (UE), comprising:
a memory;
a transceiver; and
a processor coupled to the memory and the transceiver;
wherein the UE is configured to perform:
identifying one or more candidate reserved resources, wherein the UE is configured to share its channel occupancy time (COT) with the one or more candidate reserved resources, or the UE is configured to utilize a shared COT from the one or more candidate reserved resources.

10. The UE of claim 9, wherein identifying one or more candidate reserved resources is based on at least one of following criteria:
an availability of candidate resources in consecutive slots for multi-consecutive slots transmission (MCSt) with a number of slots covering a UE processing time to decode a COT sharing information;
a resource reserved for a unicast, groupcast, or broadcast transmission with a source/destination identifier (ID) that the UE belongs to;
a channel access priority class (CAPC) level of a transmission of the UE being equal to or less than a CAPC level of the one or more candidate reserved resources; or
a maximum/remaining COT sharing duration covering the UE processing time to decode the COT sharing information and a length of the one or more candidate reserved resources.

11. The UE of claim 9, wherein the UE is further configured to perform a resource selection prior to the one or more candidate reserved resources, wherein the UE shares its COT with another UE for the one or more candidate reserved resources.

12. The UE of claim 9, wherein based on source/destination IDs in a sidelink control information (SCI), the UE is configured to determine the one or more candidate reserved resources belonging to a same unicast, groupcast and/or broadcast sidelink communication as the UE.

13. The UE of claim 9, wherein identifying the one or more candidate reserved resources is based on at least one of following criteria:
an availability of at least one candidate resource that is at least a time length away from a first slot of the one or more candidate reserved resources, wherein the time length covers a UE processing time for decoding a COT sharing information from the one or more candidate reserved resources;
a source/destination ID of an intended transmission from the UE being same as an indicated ID of the one or more candidate reserved resources;
a CAPC level of a transmission of the UE being equal to or greater than a CAPC level of the one or more candidate reserved resources; or
a maximum/remaining COT sharing duration from the one or more candidate reserved resources covering the UE processing time to decode the COT sharing information and a length of the intended transmission from the UE.

14. The UE of claim 13, wherein based on source/destination IDs in an SCI, the UE is configured to determine the one or more candidate reserved resources belonging to a same unicast, groupcast and/or broadcast sidelink communication as the UE.

15. A non-transitory machine-readable storage medium having stored thereon instructions that, when executed by a processor of a user equipment (UE), cause the UE to perform:
identifying one or more candidate reserved resources, wherein the UE is configured to share its channel occupancy time (COT) with the one or more candidate reserved resources, or the UE is configured to utilize a shared COT from the one or more candidate reserved resources.

16. The non-transitory machine-readable storage medium of claim 15, wherein identifying the one or more candidate reserved resources is based on at least one of following criteria:
an availability of candidate resources in consecutive slots for multi-consecutive slots transmission (MCSt) with a number of slots covering a UE processing time to decode a COT sharing information;
a resource reserved for a unicast, groupcast, or broadcast transmission with a source/destination identifier (ID) that the UE belongs to;
a channel access priority class (CAPC) level of a transmission of the UE being equal to or less than a CAPC level of the one or more candidate reserved resources; or
a maximum/remaining COT sharing duration covering the UE processing time to decode the COT sharing information and a length of the one or more candidate reserved resources.

17. The non-transitory machine-readable storage medium of claim 15, wherein the instructions that, when executed by the processor of the UE, cause the UE to further perform a resource selection prior to the one or more candidate reserved resources, wherein the UE shares its COT with another UE for the one or more candidate reserved resources.

18. The non-transitory machine-readable storage medium of claim 15, wherein based on source/destination IDs in a sidelink control information (SCI), the UE is configured to determine the one or more candidate reserved resources belonging to a same unicast, groupcast and/or broadcast sidelink communication as the UE.

19. The non-transitory machine-readable storage medium of claim 15, wherein identifying the one or more candidate reserved resources is based on at least one of following criteria:
an availability of at least one candidate resource that is at least a time length away from a first slot of the one or more candidate reserved resources, wherein the time length covers a UE processing time for decoding a COT sharing information from the one or more candidate reserved resources;
a source/destination ID of an intended transmission from the UE being same as an indicated ID of the one or more candidate reserved resources;
a CAPC level of a transmission of the UE being equal to or greater than a CAPC level of the one or more candidate reserved resources; or
a maximum/remaining COT sharing duration from the one or more candidate reserved resources covering the UE processing time to decode the COT sharing information and a length of the intended transmission from the UE.

20. The non-transitory machine-readable storage medium of claim 19, wherein based on source/destination IDs in an SCI, the UE is configured to determine the one or more candidate reserved resources belonging to a same unicast, groupcast and/or broadcast sidelink communication as the UE.
